(19) United States
(12) Patent Application Publication
(10) Pub. No.: US 2012/0259981 A1
(43) Pub. Date: Oct. 11, 2012

(54) Hypercasting

(75) Inventors: Matthew N. Lewinski, Minneapolis, MN (US); Martin Kacin, Palo Alto, CA (US); Michael R. Gray, Dublin, OH (US)

(73) Assignee: DELL PRODUCTS L.P., Round Rock, TX (US)

(21) Appl. No.: 13/081,378

(22) Filed: Apr. 6, 2011

(51) Int. Cl. G06F 15/173

(52) U.S. Cl. 709/225; 709/226

(57) ABSTRACT

In one embodiment, a method comprises, in response to data to be distributed to a second computing device, selecting, by a first computing device, at least one third computing device for the second computing device, wherein each of the at least one third computing device has at least a portion of a copy of the data; and notifying, by the first computing device, the second computing device information concerning each of the at least one third computing device in order for the second computing device to obtain a copy of the data from the at least one third computing device.

### TECHNICAL FIELD

The present disclosure generally relates to the distribution of a set of data and more specifically relates to managed data distribution over a network.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

The information handling system may include one or more operating systems. An operating system serves many functions, such as controlling access to hardware resources and controlling the execution of application software. Operating systems also provide resources and services to support application software. These resources and services may include a file system, a centralized configuration database (such as the registry found in Microsoft Windows operating systems), a directory service, a graphical user interface, a networking stack, device drivers, and device management software. In some instances, services may be provided by other application software running on the information handling system, such as a database server.

Some information handling systems are designed to interact with other information handling systems over a computer network connection. In particular, certain information handling systems may be designed to monitor, configure, and adjust the features, functionality, and software of other information handling systems by communicating with those information handling systems over a network connection. For example, one information handling system might be configured to manage the installation and updating of software on several other information handling systems.

In the context of the present disclosure, the term “network appliance” may refer to any device, such as an information handling system, which may include a combination of hardware, firmware, and/or software, that is capable of performing a set of operations or functions in connection with or over a computer network. The actual set of operations or functions a specific network appliance is capable of performing often depends on the hardware, firmware, and/or software included in that appliance. In the very least, however, a network appliance should be capable of being connected to a computer network.

System management appliances automate network file distribution and are available to save time for systems administration professionals and to save money for their companies. There are several file distribution solutions available that utilize peer-to-peer (P2P) file distribution and client seeding over a network, such as BitTorrent (http://www.bittorrent.com/), μTorrent (http://www.utorrent.com/), Vuze (http://www.vuze.com/), and Xunlei Thunder (http://v1.hehehunter.com/xunlei/english-xunlei-thunder-5813699/).

Many file distribution programs that utilize P2P file distribution and client seeders, seek to obtain data from multiple locations. On the other hand, systems administration professionals seeking to distribute licensed software and systems over a network to many network resources are often constrained by complex, time-consuming, and non-automated deployment. Performing systems and software deployment has become increasingly challenging and time-consuming across diverse network and hardware platforms.

There are continuous efforts to improve the quality of the file distribution over a network. Developers strive to improve file distribution management by reducing processing time and increasing network efficiency.

### SUMMARY

The present disclosure generally relates to file distribution and more specifically relates to managed data distribution over a network.

In particular embodiments, a method comprising, in response to data to be distributed to a second computing device, selecting, by a first computing device, at least one third computing device for the second computing device, wherein each of the at least one third computing device has at least a portion of a copy of the data, and notifying, by the first computing device, the second computing device information concerning each of the at least one third computing device in order for the second computing device to obtain a copy of the data from the at least one third computing device.

These and other features, aspects, and advantages of the disclosure are described in more detail below in the detailed description and in conjunction with the following figures.

### BRIEF DESCRIPTION OF THE DRAWINGS

FIG. 1 illustrates an example computer system.

FIG. 2 illustrates an example network environment.

FIG. 3 illustrates an example method of distributing a set of data over a network.

FIG. 4 illustrates an example data distribution system.

FIG. 5 illustrates an example ranking result.

FIG. 6 illustrates a second example method of distributing a set of data over a network.

### DESCRIPTION OF EXAMPLE EMBODIMENTS

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

The present disclosure is now described in detail with reference to a few embodiments thereof as illustrated in the accompanying drawings. In the following description, numerous specific details are set forth in order to provide a thorough understanding of the present disclosure. However, the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

System management appliances automate network file distribution and are available to save time for systems administration professionals and to save money for their companies. There are several file distribution solutions available and well known in the art that utilize peer-to-peer (P2P) file distribution and client seeding over a network, such as BitTorrent (http://www.bittorrent.com/), μTorrent (http://www.utorrent.com/), Vuze (http://www.vuze.com/), and Xunlei Thunder (http://v1.hehehunter.com/xunlei/english-xunlei-thunder-5813699/).

Many file distribution programs that utilize P2P file distribution and client seeders, seek to obtain data from multiple locations. On the other hand, systems administration professionals seeking to distribute licensed software and operating systems over a network are often constrained by complex, time-consuming, and non-automated deployment. Performing systems and software deployment has become increasingly challenging and time-consuming across diverse network and hardware platforms. There are deployment appliances, such as the KACE K2000 Deployment Appliance, that utilize an appliance-based architecture for managing file distribution over a network from a centralized deployment library. While a centralized deployment library or other forms of files servers can provide a highly centralized method of file sharing, they can be cumbersome because they frequently have performance bottlenecks that limit the speed at which data can be passed to and from the network clients.

To manage file distribution and improve network efficiency, particular embodiments manage file distribution through a seeding system over a network where destination clients are closer to the source clients. Particular embodiments may determine, by a first computing device, a set of data that should be distributed over the network to one or more second computing devices. In particular embodiments, a first computing device may comprise, for example and without limitation, a client, a server, a systems management appliance, a remote site appliance or any other computing device connected to a network.

In particular embodiments, a set of data may include, for example and without limitation, a portion of a file, a file system, any type of application software, such as computer software designed to help a user to perform singular or multiple related specific tasks, or an operating system, such as any software consisting of programs and data that run on computers, manage computer hardware resources, and provide common services for efficient execution of various application software. In particular embodiments, a portion of a file, file system, application software, and operating systems are contemplated for any computing platform or software framework. Examples of computing platforms, include without limitation, AmigaOS, Amiga OS4, FreeBSD, NetBSD, OpenBSD, Linux, MacOSX, Micrsoft Windows, IBM/Microsoft Operating System 2, Solaris, IBM VM/370, VM/BSEP, VM/SEP, VM/XA, VM/ESA, z/VM, Google Chrome OS, Android, Bada, Blackberry OS, iOS, Embedded Linux, Palm OS, Symbian Platform, or Windows Mobile.

In particular embodiments, the first computing device may determine one or more third computing devices wherein each third computing device has at least a portion of a copy of the set of data. In particular embodiments, the third computing device may have a portion of the copy of the set of data or an entire copy of the set of data. In particular embodiments, the first computing device may select at least one third computing device from which the second computing device can obtain a copy of the data and notify the second computing device of which third computing device has been selected.

Particular embodiments may be implemented as hardware, software, or a combination of hardware and software. For example and without limitation, one or more computer systems may execute particular logic or software to perform one or more steps of one or more processes described or illustrated herein. One or more of the computer systems may be unitary or distributed, spanning multiple computer systems or multiple datacenters, where appropriate. The present disclosure contemplates any suitable computer system. In particular embodiments, performing one or more steps of one or more processes described or illustrated herein need not necessarily be limited to one or more particular geographic locations and need not necessarily have temporal limitations. As an example and not by way of limitation, one or more computer systems may carry out their functions in “real time,” “offline,” in “batch mode,” otherwise, or in a suitable combination of the foregoing, where appropriate. One or more of the computer systems may carry out one or more portions of their functions at different times, at different locations, using different processing, where appropriate. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more computer-readable storage media may store or otherwise embody software implementing particular embodiments. A computer-readable medium may be any medium capable of carrying, communicating, containing, holding, maintaining, propagating, retaining, storing, transmitting, transporting, or otherwise embodying software, where appropriate. A computer-readable medium may be a biological, chemical, electronic, electromagnetic, infrared, magnetic, optical, quantum, or other suitable medium or a combination of two or more such media, where appropriate. A computer-readable medium may include one or more nanometer-scale components or otherwise embody nanometer-scale design or fabrication. Example computer-readable storage media include, but are not limited to, compact discs (CDs), field-programmable gate arrays (FPGAs), floppy disks, floptical disks, hard disks, holographic storage devices, integrated circuits (ICs) (such as application-specific integrated circuits (ASICs)), magnetic tape, caches, programmable logic devices (PLDs), random-access memory (RAM) devices, read-only memory (ROM) devices, semiconductor memory devices, and other suitable computer-readable storage media.

Software implementing particular embodiments may be written in any suitable programming language (which may be, for example and without limitation, procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

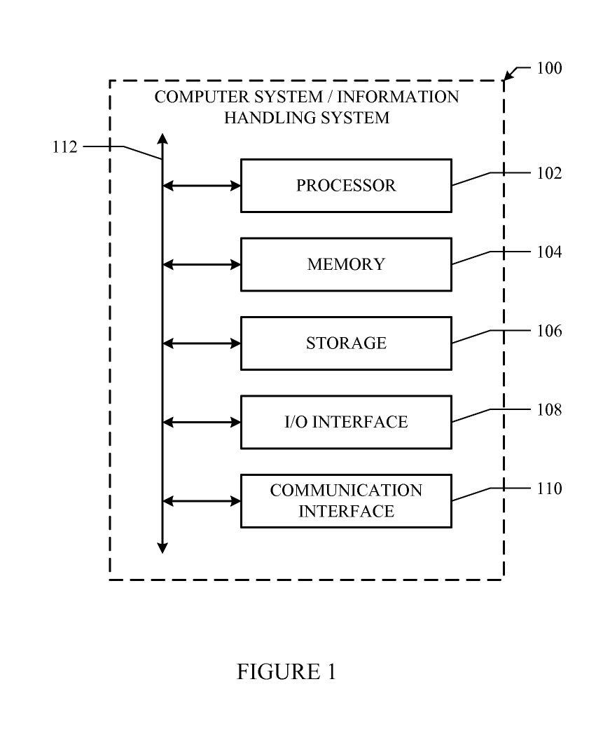

Particular embodiments may be implemented on one or more information handling systems. FIG. 1 illustrates an example computer system/information handling system 100. In particular embodiments, one or more computer systems 100 perform one or more steps of one or more methods described or illustrated herein. In particular embodiments, one or more computer systems 100 provide functionality described or illustrated herein. In particular embodiments, software running on one or more computer systems 100 performs one or more steps of one or more methods described or illustrated herein or provides functionality described or illustrated herein. Particular embodiments include one or more portions of one or more computer systems 100.

This disclosure contemplates any suitable number of computer systems 100. This disclosure contemplates computer system 100 taking any suitable physical form. As example and not by way of limitation, computer system 100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 100 may include one or more computer systems 100; be unitary or distributed; span multiple locations; span multiple machines; or reside in a cloud, which may include one or more cloud components in one or more networks. Where appropriate, one or more computer systems 100 may perform without substantial spatial or temporal limitation one or more steps of one or more methods described or illustrated herein. As an example and not by way of limitation, one or more computer systems 100 may perform in real time or in batch mode one or more steps of one or more methods described or illustrated herein. One or more computer systems 100 may perform at different times or at different locations one or more steps of one or more methods described or illustrated herein, where appropriate.

In particular embodiments, computer system 100 includes a processor 102, memory 104, storage 106, an input/output (I/O) interface 108, a communication interface 110, and a bus 112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 102 includes hardware for executing instructions, such as those making up a computer program. As an example and not by way of limitation, to execute instructions, processor 102 may retrieve (or fetch) the instructions from an internal register, an internal cache, memory 104, or storage 106; decode and execute them; and then write one or more results to an internal register, an internal cache, memory 104, or storage 106. In particular embodiments, processor 102 may include one or more internal caches for data, instructions, or addresses. The present disclosure contemplates processor 102 including any suitable number of any suitable internal caches, where appropriate. As an example and not by way of limitation, processor 102 may include one or more instruction caches, one or more data caches, and one or more translation lookaside buffers (TLBs). Instructions in the instruction caches may be copies of instructions in memory 104 or storage 106, and the instruction caches may speed up retrieval of those instructions by processor 102. Data in the data caches may be copies of data in memory 104 or storage 106 for instructions executing at processor 102 to operate on; the results of previous instructions executed at processor 102 for access by subsequent instructions executing at processor 102 or for writing to memory 104 or storage 106; or other suitable data. The data caches may speed up read or write operations by processor 102. The TLBs may speed up virtual-address translation for processor 102. In particular embodiments, processor 102 may include one or more internal registers for data, instructions, or addresses. The present disclosure contemplates processor 102 including any suitable number of any suitable internal registers, where appropriate. Where appropriate, processor 102 may include one or more arithmetic logic units (ALUs); be a multi-core processor; or include one or more processors 102. Although this disclosure describes and illustrates a particular processor, this disclosure contemplates any suitable processor.

In particular embodiments, memory 104 includes main memory for storing instructions for processor 102 to execute or data for processor 102 to operate on. As an example and not by way of limitation, computer system 100 may load instructions from storage 106 or another source (such as, for example, another computer system 100) to memory 104. Processor 102 may then load the instructions from memory 104 to an internal register or internal cache. To execute the instructions, processor 102 may retrieve the instructions from the internal register or internal cache and decode them. During or after execution of the instructions, processor 102 may write one or more results (which may be intermediate or final results) to the internal register or internal cache. Processor 102 may then write one or more of those results to memory 104. In particular embodiments, processor 102 executes only instructions in one or more internal registers or internal caches or in memory 104 (as opposed to storage 106 or elsewhere) and operates only on data in one or more internal registers or internal caches or in memory 104 (as opposed to storage 106 or elsewhere). One or more memory buses (which may each include an address bus and a data bus) may couple processor 102 to memory 104. Bus 112 may include one or more memory buses, as described below. In particular embodiments, one or more memory management units (MMUs) reside between processor 102 and memory 104 and facilitate accesses to memory 104 requested by processor 102. In particular embodiments, memory 104 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 104 may include one or more memories 104, where appropriate. Although this disclosure describes and illustrates particular memory, this disclosure contemplates any suitable memory.

In particular embodiments, storage 106 includes mass storage for data or instructions. As an example and not by way of limitation, storage 106 may include an HDD, a floppy disk drive, flash memory, an optical disc, a magneto-optical disc, magnetic tape, or a Universal Serial Bus (USB) drive or a combination of two or more of these. Storage 106 may include removable or non-removable (or fixed) media, where appropriate. Storage 106 may be internal or external to computer system 100, where appropriate. In particular embodiments, storage 106 is non-volatile, solid-state memory. In particular embodiments, storage 106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 106 taking any suitable physical form. Storage 106 may include one or more storage control units facilitating communication between processor 102 and storage 106, where appropriate. Where appropriate, storage 106 may include one or more storages 106. Although this disclosure describes and illustrates particular storage, this disclosure contemplates any suitable storage.

In particular embodiments, I/O interface 108 includes hardware, software, or both providing one or more interfaces for communication between computer system 100 and one or more I/O devices. Computer system 100 may include one or more of these I/O devices, where appropriate. One or more of these I/O devices may enable communication between a person and computer system 100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 108 for them. Where appropriate, I/O interface 108 may include one or more device or software drivers enabling processor 102 to drive one or more of these I/O devices. I/O interface 108 may include one or more I/O interfaces 108, where appropriate. Although this disclosure describes and illustrates a particular I/O interface, this disclosure contemplates any suitable I/O interface.

In particular embodiments, communication interface 110 includes hardware, software, or both providing one or more interfaces for communication (such as, for example, packet-based communication) between computer system 100 and one or more other computer systems 100 or one or more networks. As an example and not by way of limitation, communication interface 110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 110 for it. As an example and not by way of limitation, computer system 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 100 may include any suitable communication interface 110 for any of these networks, where appropriate. Communication interface 110 may include one or more communication interfaces 110, where appropriate. Although this disclosure describes and illustrates a particular communication interface, this disclosure contemplates any suitable communication interface.

In particular embodiments, bus 112 includes hardware, software, or both coupling components of computer system 100 to each other. As an example and not by way of limitation, bus 112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 112 may include one or more buses 112, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 102 (such as, for example, one or more internal registers or caches), one or more portions of memory 104, one or more portions of storage 106, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

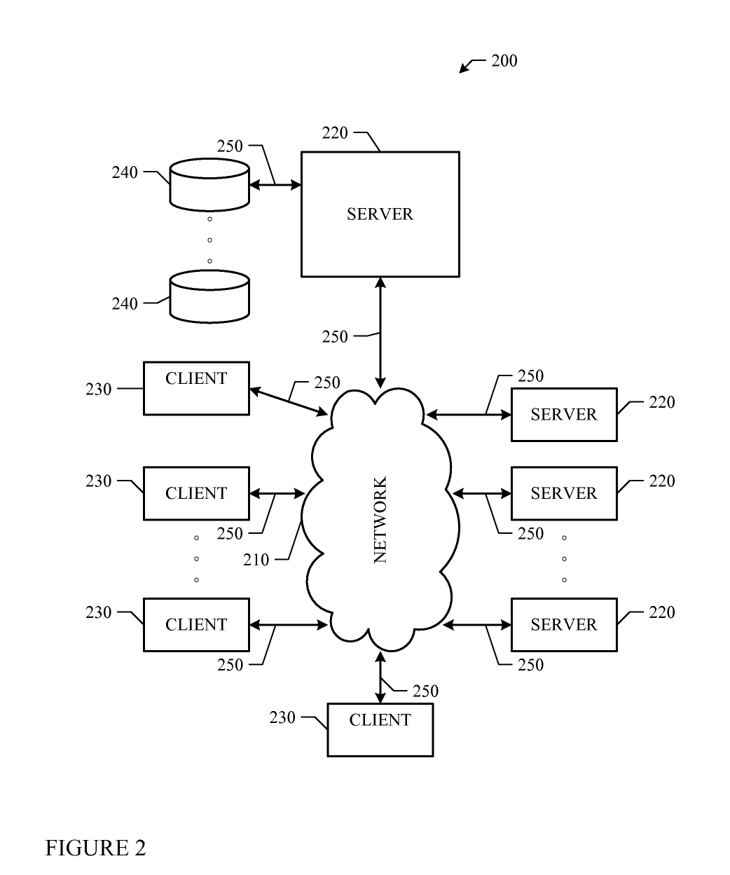

Particular embodiments may be implemented in a network environment. FIG. 2 illustrates an example network environment 200 suitable for determining a set of data to distribute, verifying that particular computing devices are authorized to receive the set of data, and distributing the set of data. Network environment 200 includes a network 210 coupling one or more servers 220 and one or more clients 230 to each other. In particular embodiments, network 210 is an intranet, an extranet, a virtual private network (VPN), a local area network (LAN), a wireless LAN (WLAN), a wide area network (WAN), a metropolitan area network (MAN), a portion of the Internet, or another network 210 or a combination of two or more such networks 210. The present disclosure contemplates any suitable network 210.

One or more links 250 couple a server 220 or a client 230 to network 210. In particular embodiments, one or more links 250 each includes one or more wireline, wireless, or optical links 250. In particular embodiments, one or more links 250 each includes an intranet, an extranet, a VPN, a LAN, a WLAN, a WAN, a MAN, a portion of the Internet, or another link 250 or a combination of two or more such links 250. The present disclosure contemplates any suitable links 250 coupling servers 220 and clients 230 to network 210.

In particular embodiments, each server 220 may be a unitary server or may be a distributed server spanning multiple computers or multiple datacenters. Servers 220 may be of various types, such as, for example and without limitation, file server, web server, news server, mail server, message server, advertising server, application server, exchange server, database server, or proxy server. In particular embodiments, each server 220 may include hardware, software, or embedded logic components or a combination of two or more such components for carrying out the appropriate functionalities implemented or supported by server 220. In particular embodiments, each server 220 may store at least a portion of a set of data. For example, a file server is generally capable of providing a location for shared disk access, i.e. shared storage of computer files (such as sets of data, software applications, operating systems, documents, sound files, images, databases, etc.) that can be accessed by various clients 230. More specifically, the various clients 230 are utilizing the storage capabilities of a file server and the file server itself is usually not performing any calculations or run programs on behalf of the clients 230. A mail server is generally capable of providing electronic mail services to various clients 230. A database server is generally capable of providing an interface for managing data stored in one or more data stores.

In particular embodiments, one or more data storages 240 may be communicatively linked to one or more servers 220 via one or more links 250. In particular embodiments, data storages 240 may be used to store various types of information. In particular embodiments, the information stored in data storages 240 may be organized according to specific data structures. In particular embodiment, each data storage 240 may be a relational database. Particular embodiments may provide interfaces that enable servers 220 or clients 230 to manage, e.g., retrieve, modify, add, or delete, the information stored in data storage 240.

In particular embodiments, each client 230 may be an electronic device including hardware, software, or embedded logic components or a combination of two or more such components and capable of carrying out the appropriate functionalities implemented or supported by client 230. For example and without limitation, a client 230 may be a desktop computer system, a notebook computer system, a netbook computer system, a handheld electronic device, a mobile telephone, a remote site appliance, or a master site appliance. The present disclosure contemplates any suitable clients 230. A client 230 may enable a network user at client 230 to access network 210. A client 230 may enable its user to communicate with other users at other clients 230. In particular embodiments, a client 230 may store at least a portion of a set of data. In particular embodiments, a client 230 may be a destination 234 and receive at least a portion of a set of data.

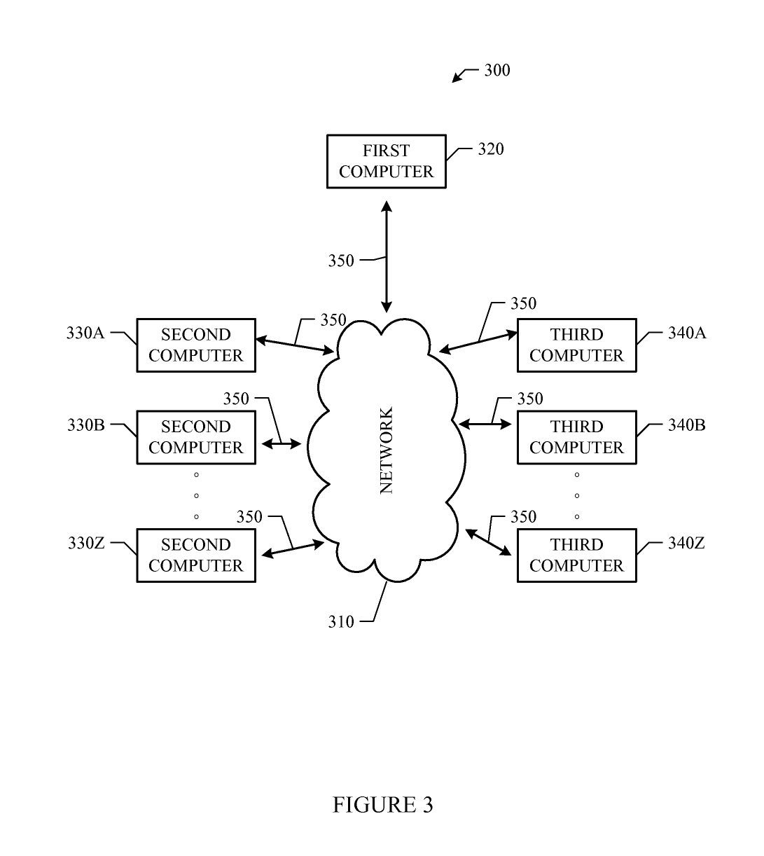

FIG. 3 illustrates an example distribution system 300 having a first computing device 320, one or more second computing devices 330, and one or more third computing devices 340 each communicatively linked to network 310 through links 350. FIG. 3 contemplates any suitable network environment as described in FIG. 2 above in detail or any other of various network infrastructures.

In particular embodiments, a first computing device 320 may comprise a master site, such as a controller. One or more second computing devices 330 and one or more third computing devices 340 may comprise one or more remote site appliances or one or one or more clients. In particular embodiments, the one or more second computing devices 330A, 330B, to 330Z may require a set of data in either a push or pull scenario. In particular embodiments, the one or more third computing devices 340A, 330B, to 330Z may have the set of data that a particular second computing device 330A requires. In particular embodiments, the first computing device 320 may be any of the one or more third computing devices 340A, 340B, to 340Z. More specifically, the first computing device 320 may also have at least a portion of the set of data that is required by the second computing device 330A.

In particular embodiments the first computing device may determine a set of data to distribute based on a user input into a computing device. In particular embodiments, the first computer may determine a set of data to distribute based on a distribution schedule for a particular set of data.

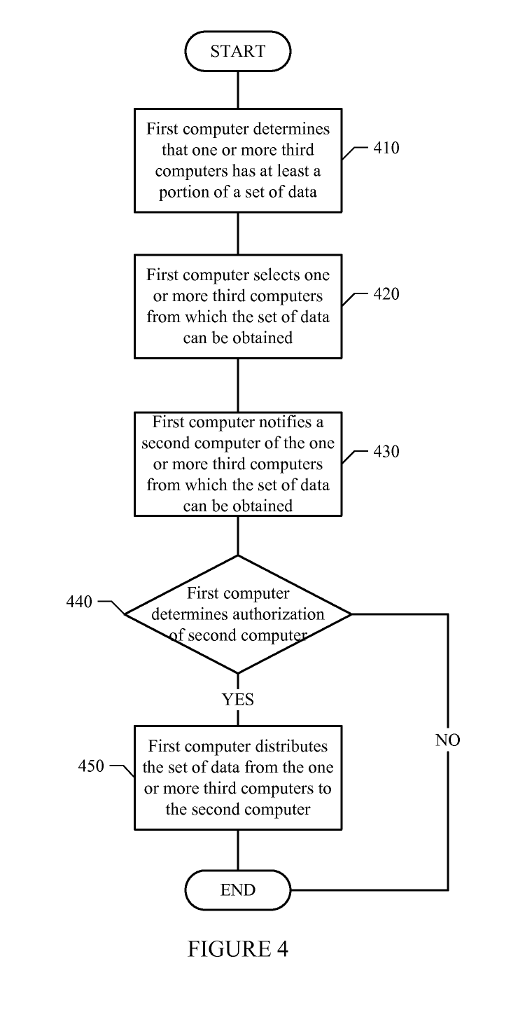

FIG. 4 illustrates an example method of a first computing device 320 selecting and authorizing a set of data to be distributed from a third computing device 340 to a second computing device 330 when a set of data is to be distributed to one or more second computing devices 330.

A set of data may be distributed from a third computing device 340 to a second computing device using various push or pull scenarios. In particular embodiments, it may be determined that a set of data is to be distributed to a second computing device 330 based on a network user inputting information into the first computing device 320 or automatically by the first computing device 320 based on the topography of the system. In particular embodiments, it may be determined that a set of data is to be distributed to a second computing device 330 based on a network user inputting information into the second computing device 330 or by the second computing device 330 automatically generating a request for the set of data based on the system requirements of the second computing device 330. In particular embodiments, it may be determined that a set of data is to be distributed to a second computing device 330 based on a distribution schedule for a particular set of data. In particular embodiments it may be determined that a set of data is to be distributed to a second computing device 330 based on a problem with the distribution system 300, or more specifically, with the second computing device 330 itself.

In particular embodiments, the first computing device 320 may determine whether the second computing device 330A, 330B, to 330Z is authorized to receive at least a portion of the set of data. Particular embodiments of the first computing device 320 may determine whether each second computing device 330A, 330B, to 330Z is authorized to receive the set of data by determining whether each second computing device has licensed permission to receive at least a portion of the set of data. In particular embodiments, if the second computing device 330A is not authorized to obtain at least a portion of the set of data, the first computing device 320 may notify the second computing device that the request is denied.

In particular embodiments, the first computing device 320 determines that one or more third computing devices 340A, 340B, to 340Z has at least a portion of the set of data, as illustrated in step 410. The set of data may be stored on a single third computing device 340 or at many different third computing devices 340A, 340B, to 340Z, such as computers and servers, in databases, etc., around the world. In order for the first computer 320 to determine that a third computing device 340 has at least a portion of the set of data, in particular embodiments, the first computer 320 may auto-discover network-wide hardware, such as the third computing devices 340 and their software configurations. In particular embodiments, a network user through a second computing device 330 may perform a search by requesting that the first computing device 320 discover network-wide hardware and their software configurations. In particular embodiments, the first computing device 320 constantly maintains the network topography. For example, the first computing device 320 may have at any moment an updated list of each third computing device 340A, 340B, to 340Z and the at least a portion of sets of data stored on each third computing device 340A, 340B, to 340Z.

Due to the potentially large size of a given network, in particular embodiments, network users may rely on different types of computer-implemented tools on the first computing device 320 to locate the desired set of data at different third computing devices 340A, 340B, to 340Z. To locate a set of data at a given third computing device 340, the network user typically provides a short phrase or a few keywords describing the set of data. The first computing device 320 conducts a search based on the request using various search algorithms and generates a search result that identifies one or more third computing devices 340A, 340B, to 340Z having at least a portion of the set of data. The third computing devices 340 having at least a portion of the set of data are presented to the network user, for example, as a list of network addresses representing various third computing devices 340A, 340B, to 340Z that have at least a portion of the set of data. In particular embodiments, the third computing devices 340A, 340B, to 340Z may be displayed as a link that specifies where the corresponding set of data is located and the mechanism for retrieving it.

In particular embodiments, the first computing device 320 may implement many other functionalities in addition to merely identifying the third computing devices 340 as a part of the search process. For example, the first computing device 320 may rank the third computing devices 340A, 340B, to 340Z having at least a portion of the set of data according to their relative degrees of relevance with respect to the search. The first computing device 320 may also provide additional identifying information about the third computing device 340, the ranking algorithm, or the set of data being requested.

As illustrated in step 420, the first computing device 320 selects one or more third computing device 340A, 340B, to 340Z from which the set of data can be obtained. In particular embodiments, the first computing device 320 randomly selects a subset of all third computing devices 340A, 340B, to 340Z having at least a portion of the set of data to be distributed to the second computing device 330. In particular embodiments, the first computing device may randomly select a subset of all third computing devices 340A, 340B, to 340Z based on a hash function, round-robin selections, or whether the third computing devices 340A, 340b, to 340Z are idle. In particular embodiments, any random generation of a subset of the third computing devices 340A, 340B, to 340Z having at least a portion of the set of data will suffice.

In particular embodiments, the first computing device 320 may select one or more third computing devices 340A, 340B, to 340Z based on a rank of the third computing device 340. In particular embodiments, the third computing devices 340A, 340B, to 340Z that have at least a portion of the set of data may be ranked relative to a given second computing device 330A. In particular embodiments, the third computing devices 340A, 340B, to 340Z that have at least a portion of the set of data may be ranked relative to a given second computing device 330A based on the location of the second computing device 330A, a location of each of the plurality of third computing devices 340A, 340B, to 340Z, a current workload of each of the plurality of the third computing devices 340A, 340B, to 340Z, and a percentage of the copy of the data each of the plurality of computing devices 340A, 340B, to 340Z has. In particular embodiments, the first computing device 320 may perform the ranking operation in order to rank the third computing devices 340A, 340B, to 340Z having at least a portion of the set of data that are optimal for the given second computing device 330A.

In particular embodiments, for example, but not by way of limitation, the third computing devices 340A, 340B, to 340Z having a portion of the set of data may be ranked by latency, bandwidth, load balancing, network location, specified controls, or central processing unit (CPU) usage. In particular embodiments, latency may be the perceived response time of the computing devices having at least a portion of the set of data or the actual time it takes for a packet of data to get from one designated point to another. In particular embodiments, latency may be measured between the second computing device 330A and each of the one or more third computing devices 340A, 340B, to 340Z identified as having at least a portion of the set of data.

In particular embodiments, the third computing devices 340A, 340B, to 340Z may be ranked by network location in order to have fewer network hops between each of the third computing devices 340A, 340B, to 340Z and the second computing device 330A. In particular embodiments, the third computing devices 340A, 340B, to 340Z may be ranked according to the CPU usage of the third computing devices 340 having at least a portion of the set of data so that only idle computing devices are used as third computing devices 340.

In particular embodiments, the third computing devices 340A, 340B, to 340Z may be ranked according to the CPU usage so that the impact on already working CPUs is minimized. Network resources 520, 530, 540, 550, 560 are presented according to available CPU bandwidth. Consequently, network resource 520 is presented first (i.e., at the top of search result 500) followed by network resource 530, network resource 540, and so on. That is, network resource 520 has greater available CPU than network resource 530, network 540, and so on. For example, if the first computing device 320 searched the distribution system 300 for a set of data, such as Windows Operating System (OS), a ranking result 500 may be displayed for at least five network resources 520, 530, 540, 550, 560 that have at least a portion of Windows OS. In search result 500, for example, network resource 520 is presented first because it has Windows OS and the most available CPU bandwidth. Other network resources 530, 540, 550, 560 also have copies of Windows OS but are presented after network resource 520 because they have less available CPU bandwidth.

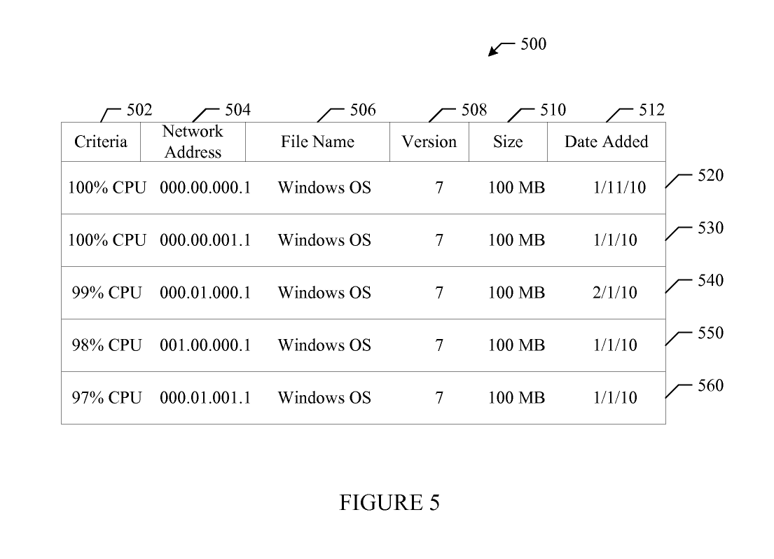

In particular embodiments, the ranking of the third computing devices 340A, 340B, to 340Z having at least a portion of the set of data may be determined by a ranking algorithm implemented by the first computing device 320. Given a request for a set of data a set of network resources identified in response to the request, the ranking algorithm ranks the network resources in the set according to their relative degrees of relevance with respect to the request. More specifically, in particular embodiments, the network resources that are relatively more relevant to the request are ranked higher than the network resources that are relatively less relevant to the request, as illustrated, for example, in FIG. 5.

In particular embodiments, as a part of the ranking process, the first computing device 320 using the ranking algorithm may determine a ranking score for each of the third computing devices 340A, 340B, to 340Z in the set. For example, the third computing devices 340 that are relatively more relevant to the search may receive relatively higher ranking scores than the third computing devices 340 that are relatively less relevant to the search for a set of data. The third computing devices 340 in the set are then ranked according to their respective ranking scores.

In particular embodiments, the first computing device 320 notifies the second computing device 330 of the one or more third computing devices 340A, 340B, to 340Z from which the set of data can be obtained, as illustrated in step 430.

FIG. 5 illustrates an example result 500 that identifies five network resources and more specifically, five computing devices 520, 530, 540, 550, 560 having at least a portion of the set of data. Result 500 is generated by the first computing device 320 by determining which of one or more third computing devices 340A, 340B, to 340Z have at least a portion of the set of data in order to notify the second computing device 330 of the third computing device 340 from which the set of data can be obtained. Note that only five computing devices are illustrated in order to simplify the discussion. In practice, a result may identify tens, hundreds, or thousands of network resources. Further, the result may identify the network resources based on random selection by the first computing device 320 or the result may identify the network resources that the first computing device 320 has selected that are most relevant to a give second computing device 330A.

For example, network resources 520, 530, 540, 550, 560 each include a rank represented by its position in the list, a ranking criteria 502 that displays the criteria by which the computing devices are ranked, a network address 504 displaying the network location of the network resources, a file name 506 representing the at least a portion of the set of data, a file version 508 or a build, a file size 510, and a date added 512 displaying the date that the set of data was acquired by the third computing device 340 or became available to other network resources.

In particular embodiments, a first computing device 320 determines whether the second computing device 330 is authorized to receive the set of data, as illustrated in step 440. In particular embodiments, for example, a set of data cannot be distributed from the third computing device 340 to the second computing device 330 unless the first computing device 320 determines that the second computing device 330 has authorization to receive and execute the set of data. In particular embodiments, the first computing device 320 determines that one or more of the second computing devices 330A, 330B, to 330Z is authorized to receive the set of data. Authorization may be password-based, identity-based, form-based, token-based, or certificate-based and the like. Authorization may be for a periodic or perpetual.

In particular embodiments, a set of data cannot be distributed to a second computing device 330 unless the first computing device 320 determines that the second computing device 330 has licensed permission to receive and execute the set of data. In particular embodiments, the first computing device 320 determines that one or more of the second computing devices 330A, 330B, to 330Z has licensed permission to receive the set of data. In particular embodiments, for example, licensed permission may be license authorization. License authorization may be, for example, a serial number or other type of access code that may be used by the second computing device 330 to access at least a part of the set of data. License authorization may have an accompanying end-user license agreement that protects the owner of the set of data under existing intellectual property laws. License authorization may be for a period of time or perpetual.

In particular embodiments, the first computing device 320 notifies each of the one or more third computing devices 340A, 340B, to 340Z having at least a portion of the set of data information concerning the second computing device 330A. In particular embodiments, the first computing device 320 notifies each of the one or more third computing devices 340A, 340B, to 340Z information concerning the second computing device 330, more specifically, whether the second computing device 330A is authorized to receive at least a portion of the set of data.

In particular embodiments, the first computing device 320 manages the distribution of the set of data from the one or more third computing devices 340A, 340B, to 340Z to the second computing device 330, which is an authorized computing device, as illustrated in step 450. The first computing device 320 will begin the distribution of the set of data from one or more of the third computing devices 340A, 340B, to 340Z to one or more of the authorized second computing devices 330A, 330B, to 330Z. In particular embodiments, the authorized second computing device 330A, 330B, to 330Z will receive the set of data from the third computing device 340A, 340B, or to 340Z, which has an entire set of data. In particular embodiments, the authorized second computing device 330A, 330B, to 330Z will receive the set of data from more than one third computing device 340A, 340B to 340Z, each third computing device 340 having at least a portion of the set of data.

In particular embodiments, the first computing device 320 manages distribution of the set of data so that network usage is optimized. If during the distribution of data from the third computing device 340 to the second computing device 330, for example, additional third computing devices 340 become available that have at least a portion of the set of data and are ranked higher than the previously available third computing devices 340 so as to optimize network usage, the first computing device 320 may alter distribution of the set of data to utilize the additional third computing devices 340 in addition to or instead of the original third computing devices 340.

In particular embodiments, the first computing device 320 manages distribution of the set of data in the event of a failure during the distribution of the set of data from the third computing device 340 to the authorized second computing device 330 in order to prevent loss of any data. Failures may occur during distribution for any number of reasons, including but not by way of limitation, failures caused by the second computing device 330, the third computing device 340, or a general failure of network 310. In particular embodiments, for example, any one of the third computing devices 340A, 340B to 340Z may go offline during distribution of the set of data between the third computing device 340A, 340B, to 340Z to the second computing device 330.

In the event of a distribution failure caused by the second computing device 330, in particular embodiments, the first computing device 320 may resume distribution from the third computing device 340 to the second computing device 330. In the event of a distribution failure cased by the third computing device 340A, 340B, to 340Z, the first computing device 320 may attempt to resume distribution from the same third computing device 340A or the first computing device 320 may resume distribution from a different third computing device 340B to 340Z.

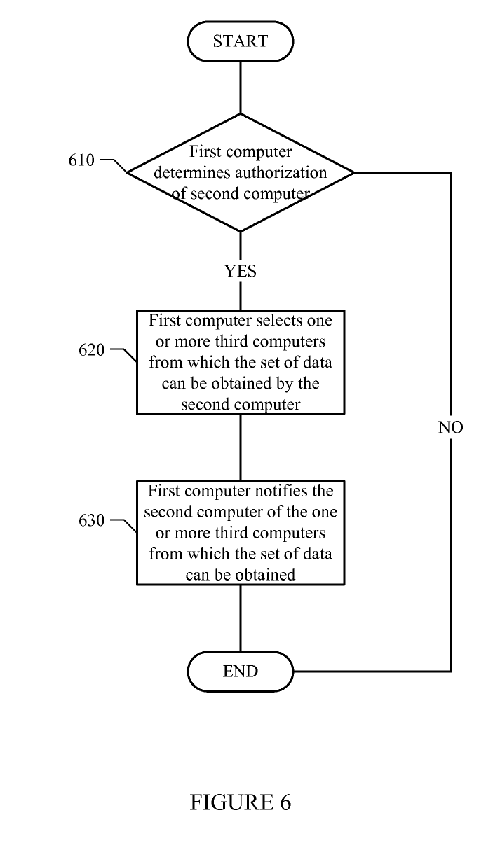

FIG. 6 illustrates an example method of a first computing device 320 selecting and authorizing a set of data to be distributed from a third computing device 340 to a second computing device 330 when a set of data is to be distributed to one or more second computing devices 330. In particular embodiments, the first computing device 320 frequently updates a list of the one or more third computing devices 340A, 340B, to 340Z and the at least a portion of the copies of the set of data that each third computing devices 340A, 340B, to 340Z have. In particular embodiments, a network user through a second computing device 330 may perform a search through the first computing device 320 of the at least a portion of a copy of the data that is stored at the third computing devices 340A, 340B, to 340Z.

In particular embodiments, the first computing device 320 determines a second computing device 330A is authorized to receive the set of data, as illustrated in step 610. As described in detail above, authorization may occur in various forms or formats. In particular embodiments, for example, a set of data cannot be distributed from the one or more third computing devices 340A, 340B, to 340Z to the second computing device 330A unless the first computing device 320 first determines that the second computing device 330A has authorization to receive and execute the set of data. If the second computing device 330A is not authorized to receive at least a portion of the set of data the process ends.

Once the first computing device 330 has made a determination that the second computing device 330A is authorized to receive at least a portion of the set of data, the first computing device 320 selects one or more third computing devices 340A, 340B, to 340Z from which the set of data can be obtained by the second computing device 330A, as illustrated in step 620. As discussed in detail above, selection of the one or more third computing devices 340A, 340B, to 340Z by the first computing device 320 may be random based on conditions of the third computing devices 340A, 340B, to 340Z or may be particular and relative to the second computing device 330A.

In particular embodiments, the first computing device 320 notifies the second computing device 330A of the one or more third computing devices 340A, 340B, to 340Z from which at least a portion of the set of data can be obtained, as illustrated in step 630. As discussed above, FIG. 5 illustrates an example result identifying specific one or more third computing devices 520, 530, 540, 550, 560 having at least a portion of the set of data from which the second computer 330A can obtain at least a portion of the set of data.

In particular embodiments, once the second computing device 330A is notified of the one or more third computing devices 340A, 340B, to 340Z having at least a portion of the set of data, one or more of the third computing devices 340A, 340B, 340Z begin distributing at least a portion of the set of data directly to the second computing device 330A. In particular embodiments, an individual third computing device 340A may transfer the at least a portion of the set of data to the second computing device 330A. In particular embodiments, more than one third computing device 340A, 340B, to 340Z may each transfer a portion of the set of data in parallel.

In particular embodiments, if the distribution of at least a portion of the set of data from the third computing device 340 to the second computing device 330 completely fails, for example, it is no longer possible for the second computing device 330 to get at least a portion of the copy of the data from any of the one or more third computing devices 340A, 340B, to 340Z, then the first computing device may select and notify the second computing device 330 of additional one or more third computing devices 340 from which the set of data can be obtained.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising:
in response to data to be distributed to a second computing device,
selecting, by a first computing device, at least one third computing device for the second computing device, wherein each of the at least one third computing device has at least a portion of a copy of the data; and
notifying, by the first computing device, the second computing device information concerning each of the at least one third computing device in order for the second computing device to obtain a copy of the data from the at least one third computing device.

2. The method of claim 1, wherein selecting, by the first computing device, the at least one third computing device for the second computing device comprises:
ranking, by the first computing device, a plurality of third computing devices with respect to the second computing device, wherein each of the plurality of third computing devices has at least a portion of a copy of the data; and
selecting, by the first computing device, from the plurality of third computing devices at least one highest ranked third computing device for the second computing device.

3. The method of claim 2, wherein the plurality of third computing devices are ranked with respect to the second computing device based on a location of the second computing device, a location of each of the plurality of third computing devices, a current workload of each of the plurality of third computing devices, and a percentage of the copy of the data each of the plurality of third computing devices has.

4. The method of claim 1, further comprising notifying, by the first computing device, each of the at least one third computing device information concerning the second computing device.

5. The method of claim 1, further comprising:
receiving, at the first computing device, from the second computing device a request for the data;
determining, by the first computing device, whether the second computing device is authorized to obtain a copy of the data; and
if the second computing device is not authorized to obtain a copy of the data, notifying, by the first computing device, the second computing device that the request is denied.

6. The method of claim 1, further comprising in response to the data becoming available, determining, by the first computing device, whether the second computing device should receive a copy of the data.

7. The method of claim 1, further comprising determining, by the first computing device, one or more third computing devices, wherein each of the one or more third computing devices has at least a portion of a copy of the data.

8. A first system comprising:
a memory comprising instructions executable by one or more processors; and
the one or more processors coupled to the memory and operable to execute the instructions the one or more processors being operable when executing the instructions to:
in response to data to be distributed to a second system,
select at least one third system for the second system, wherein each of the at least one third system has at least a portion of a copy of the data; and
notify the second system information concerning each of the at least one third system in order for the second system to obtain a copy of the data from the at least one third system.

9. The first system of claim 8, wherein select at least one third system for the second system comprises:
rank a plurality of third systems with respect to the second system, wherein each of the plurality of third systems has at least a portion of a copy of the data; and
select from the plurality of third systems at least one highest ranked third computing system for the second system.

10. The first system of claim 9, wherein the plurality of third systems are ranked with respect to the second system based on a location of the second system, a location of each of the plurality of third systems, a current workload of each of the plurality of third systems, and a percentage of the copy of the data each of the plurality of third systems has.

11. The first system of claim 8, wherein the one or more processors being further operable when executing the instructions to notify each of the at least one third system information concerning the second system.

12. The first system of claim 8, wherein the one or more processors being further operable when executing the instructions to:
receive from the second system a request for the data;
determine whether the second system is authorized to obtain a copy of the data; and
if the second system is not authorized to obtain a copy of the data, notify the second system that the request is denied.

13. The first system of claim 8, wherein the one or more processors being further operable when executing the instructions to determine, in response to the data becoming available, whether the second system should receive a copy of the data.

14. The first system of claim 8, wherein the one or more processors being further operable when executing the instructions to determine one or more third systems, wherein each of the one or more third systems has at least a portion of a copy of the data.

15. One or more computer-readable non-transitory storage media embodying software operable when executed by a first computer system to:
in response to data to be distributed to a second computer system,
select at least one third computer system for the second computer system, wherein each of the at least one third computer system has at least a portion of a copy of the data; and
notify the second computer system information concerning each of the at least one third computer system in order for the second computer system to obtain a copy of the data from the at least one third computer system.

16. The media of claim 15, wherein select the at least one third computer system for the second computer system comprises:
rank, by the first computer system, a plurality of third computer systems with respect to the second computer system, wherein each of the plurality of third computer systems has at least a portion of a copy of the data; and
select, by the first computer system, from the plurality of third computer systems at least one highest ranked third computer system for the second computer system.

17. The media of claim 16, wherein the plurality of third computer systems are ranked with respect to the second computer system based on a location of the second computer system, a location of each of the plurality of third computer systems, a current workload of each of the plurality of third computer systems, and a percentage of the copy of the data each of the plurality of third computer systems has.

18. The media of claim 15, wherein the software is further operable when executed by the first computer system to notify, by the first computer system, each of the at least one third computer system information concerning the second computer system.

19. The media of claim 15, wherein the software is further operable when executed by the first computer system to:
receive, at the first computer system, from the second computer system a request for the data;
determine, by the first computer system, whether the second computer system is authorized to obtain a copy of the data; and
if the second computer system is not authorized to obtain a copy of the data, notify, by the first computer system, the second computer system that the request is denied.

20. The media of claim 15, wherein the software is further operable when executed by the first computer system to in response to the data becoming available, determine, by the first computer system, whether the second computer system should receive a copy of the data.

21. The media of claim 15, wherein the software is further operable when executed by the first computer system to determine, by the first computer system, one or more third computer systems, wherein each of the one or more third computer systems has at least a portion of a copy of the data.
